(19) United States
(12) Patent Application Publication
(10) Pub. No.: US 2016/0346677 A1
(43) Pub. Date: Dec. 1, 2016

(54) CHANCE-BASED WAIT TIME REDUCTIONS

(71) Applicant: KABAM, INC., San Francisco, CA (US)

(72) Inventor: John KIM, San Francisco, CA (US)

(73) Assignee: KABAM, INC., San Francisco, CA (US)

(21) Appl. No.: 14/014,240

(22) Filed: Aug. 29, 2013

(51) Int. Cl. A63F 13/00

(52) U.S. Cl. CPC A63F 13/00

(57) ABSTRACT

Approaches to facilitating chance-based wait time reductions are provided. A first action may be executed in a game space in response to receiving a first action request from a first user. The first action may be associated with a first wait time. The first wait time may prevent execution of corresponding actions for an amount of time after the reception of the first action request. An item instance of a first wait time reduction item may reduce a wait time associated with an executed action in the game space by a reduction time upon activation. The first wait time for the first action may be reduced by a first reduction time responsive to activation of a first item instance by the first user for the first action. The first reduction time may not be apparent to the first user prior to the activation of the first item instance.

### FIELD OF THE DISCLOSURE

This disclosure relates generally to chance-based wait time reductions.

### BACKGROUND

Traditional sales promotions such as discounting of prices may be utilized for virtual items to boost short-term profits associated with the virtual items. However, while traditional sales promotions may have the effect of boosting short-term profits, such promotions may have lingering long-term effects relating to profitability from the virtual items or perceived values of the virtual items by users. For example, discounting virtual item prices generally provides a temporary spike in sales, and then causes a longer period of decreased sales once the regular virtual item prices are restored. Thus, among other issues, the negative effects of direct discounting of virtual item prices may outweigh short-term gains.

### SUMMARY

One aspect of the disclosure relates to a system configured to facilitate chance-based wait time reductions in an electronic game (e.g., an online game or other electronic game), in accordance with one or more implementations. In exemplary implementations, offers to purchase item instances of a chance-based wait time reduction item may be presented to users where specific reduction times of the chance-based item instances may not be apparent to the users at the time of sale. The chance-based item instances may, for example, enable other incentives (e.g., increasing the potential wait time reduction power that one of the chance-based item instances may provide, increasing the chance of obtaining one of the chance-based item instances with a high wait time reduction power, etc.) to be provided in addition to, or alternatively, to direct discounting of non-chanced-based offerings. As such, the chance-based wait time reduction items may provide the benefits of traditional sales promotions with respect to wait time reduction items without its associated lingering long-term negative effects.

By way of example, the system may be configured such that, upon activation of a purchased item instance of the chance-based wait time reduction, a wait time associated with an executed action in a game space may be reduced by a reduction time associated with the purchased item instance of the wait time reduction item. The system may be further be configured such that the reduction time associated with the purchased item instance may not be apparent to the users prior to the activation of the purchased item instance. As such, each of the presented item instances may provide users with a chance to reduce a wait time associated with an executed action by one of a plurality of reduction times associated with the wait time reduction item.

In some implementations, the system may include one or more servers. The server(s) may be configured to communicate with one or more client computing platforms according to a client/server architecture. The users may access the system and/or a virtual space (e.g., a virtual world, a game space, etc.) via the client computing platforms.

The server(s) may be configured to execute one or more computer program modules to facilitate chance-based wait time reductions. The computer program modules may include one or more of a game module, a store module, a wait time module, an item manager module, and/or other modules. In some implementations, the client computing platforms may be configured to execute one or more computer program modules that are the same as or similar to the computer program modules of the server(s) to facilitate chance-based wait time reductions.

The game module may be configured to execute a game instance of a game space. The game module may be configured to facilitate presentation of views of the game space to users. The game module may be configured to facilitate interaction of the users with the game space. The interaction may be facilitated by executing actions in the game space in response to receiving action requests from the users for the actions. The actions may be associated with wait times that prevent execution of corresponding actions for an amount of time after the reception of the action requests. The actions may include a first action executed in the game space in response to receiving a first action request from a first user. The first action may be associated with a first wait time.

In certain implementations, the corresponding actions of an action (that are prevented from execution for the period associated with the wait time of the action) may include actions having a common action type with the action. As an example, the common action type may include a virtual construction or upgrade of one or more virtual structures. At least some of the wait times may relate to the construction or upgrade of the one or more virtual structures. As another example, the common action type may include simulated research to achieve one or more levels of virtual knowledge. At least some of the wait times may relate to achievement of the one or more levels of virtual knowledge. As another example, the common action type may include simulated training. At least some of the wait times may relate to one or more simulated training goals. As another example, the common action type may include a traversal of a virtual distance by one or more virtual units. At least some of the wait times may relate to the traversal of the virtual distance.

The store module may be configured to present a store interface to the users. The store interface may present offers to the users to purchase item instances of wait time reduction items. The wait time reduction items may include a first wait time reduction item. An item instance of the first wait time reduction item may reduce a wait time associated with an executed action in the game space by a reduction time upon activation. As used herein, the term “offer” may refer to an offer or a request for an offer.

The wait time module may be configured to reduce the first wait time for the first action by a first reduction time. The first wait time for the first action may be reduced by the first reduction time responsive to activation of a first item instance by the first user for the first action. In some implementations, the store module and/or the wait time module may be configured such that the first reduction time may not be apparent to the first user prior to the activation of the first item instance.

The item manager module may be configured to manage the wait time reduction items. In some implementations, the item manager module may be configured to associate the first wait time reduction item with probabilities that an item instance of the first wait time reduction item will reduce a wait time associated with an executed action in the game space by individual reduction times upon activation by the users. The probabilities may include a first probability that an item instance of the first wait time reduction item will reduce a wait time associated with an executed action in the game space by the first reduction time upon activation.

In certain implementations, the wait time module may be configured to initiate a stochastic selection of one of a plurality of reduction times in accordance with the probabilities. The stochastic selection may be initiated by the wait time module responsive to the activation of the first item instance. The first reduction time may be selected based on the stochastic selection as a reduction time for reducing the first wait time for the first action.

In various implementations, the association of the first wait time reduction item with the probabilities by the item manager module may comprise an association of the first wait time reduction item with the probabilities after a purchasing of the first item instance by the first user. In some implementations, at a time of the purchase of the first item instance, the first wait time reduction item may be associated with other probabilities that an item instance of the first wait time reduction item will reduce a wait time associated with an executed action in the game space by individual reduction times upon activation by the users. In one implementation, the association of the first reduction item with the probabilities by the item manager module may modify the first reduction item to be associated with the probabilities such that the reduction of the first wait time for the first action is based on the modification of the first reduction item.

In certain implementations, the association of the first wait time reduction item with the probabilities by the item manager module may comprise an association of the first wait time reduction item with the probabilities prior to a purchasing of the first item instance by the first user. In some implementations, the item manager module may be configured to, after the purchase of the first item instance, associate the first wait time reduction item with other probabilities that an item instance of the first wait time reduction item will reduce a wait time associated with an executed action in the game space by individual reduction times upon activation by the users.

In one implementation, a second item instance of the first wait time reduction item may be purchased by a second user after the association of the first-wait time reduction item with the other probabilities. The actions may include a second action executed in the game space in response to receiving a second action request from the second user. The second action may be associated with a second wait time. Wait time module may be configured to reduce the second wait time for the second action in accordance with the other probabilities responsive to activation of the second item instance by the second user for the second action.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 illustrates a system configured to facilitate chance-based wait time reductions, in accordance with one or more implementations.

FIG. 2 illustrates a user interface depicting an information window that indicates requested actions and times remaining for the requested actions to be completed, in accordance with one or more implementations.

FIG. 3 illustrates a store interface that presents wait time reduction items for sale, in accordance with one or more implementations.

FIG. 4 illustrates a method of facilitating chance-based wait time reductions, in accordance with one or more implementations.

FIG. 5 illustrates a method of facilitating probability-associated wait time reductions, in accordance with one or more implementations.

### DETAILED DESCRIPTION

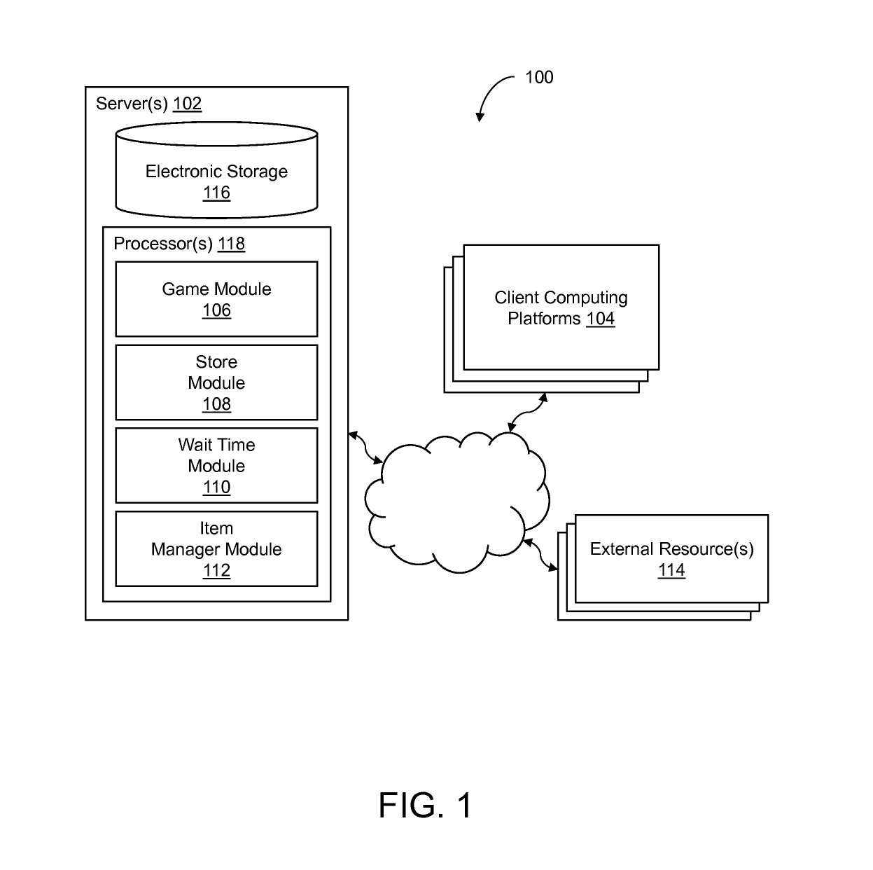

FIG. 1 illustrates a system 100 configured to facilitate chance-based wait time reductions, in accordance with one or more implementations. In some implementations, system 100 may include one or more servers 102. Server(s) 102 may be configured to communicate with one or more client computing platforms 104 according to a client/server architecture. The users may access system 100 and/or a virtual space (e.g., a virtual world, a game space, etc.) via client computing platforms 104.

Server(s) 102 may be configured to execute one or more computer program modules to facilitate chance-based wait time reductions. The computer program modules may include one or more of a game module 106, a store module 108, a wait time module 110, an item manager module 112, and/or other modules. In some implementations, client computing platforms 104 may be configured to execute one or more computer program modules that are the same as or similar to the computer program modules of server(s) 102 to facilitate chance-based wait time reductions.

Game module 106 may be configured to execute a game instance of a game space. In some implementations, the game space may be a virtual space. As such, a game instance of the game space may be an instance of the virtual space. Game module 106 may, for example, include a space module (not shown for illustrative convenience) configured to implement the instance of the virtual space executed by the computer modules to determine state of the virtual space. The state may then be communicated (e.g., via streaming visual data, via object/position data, and/or other state information) from server(s) 102 to client computing platforms 104 for presentation to users. The state determined and transmitted to a given client computing platform 104 may correspond to a view for a user character being controlled by and/or associated with a user via the given client computing platform 104. The state determined and transmitted to a given client computing platform 104 may correspond to a location in the virtual space. The view described by the state for the given client computing platform may correspond, for example, to the location from which the view is taken, the location the view depicts, and/or other locations, a zoom ratio, a dimensionality of objects, a point-of-view, and/or view parameters of the view. One or more of the view parameters may be selectable by the user.

The instance of the virtual space may comprise a simulated space that is accessible by users via clients (e.g., client computing platforms 104) that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the computer modules may be synchronous, asynchronous, and/or semi-synchronous.

The above description of the manner in which state of the virtual space is determined by the space module is not intended to be limiting. The space module may be configured to express the virtual space in a more limited, or more rich, manner. For example, views determined for the virtual space representing the state of the instance of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual space are contemplated.

Within the instance(s) of the virtual space executed by the space module, users may control characters, objects (e.g., structures, items, and/or other objects), simulated physical phenomena (e.g., wind, rain, earthquakes, and/or other phenomena), and/or other elements within the virtual space to interact with the virtual space and/or each other. The user characters may include avatars. As used herein, the term “user character” may refer to an object (or group of objects) present in the virtual space that represents an individual user. The user character may be controlled by and/or associated with the user with which it is associated. The user-controlled element(s) may move through and interact with the virtual space (e.g., non-user characters in the virtual space and/or other objects in the virtual space). The user-controlled elements controlled by and/or associated with a given user may be created and/or customized by the given user. The user may have an “inventory” of virtual goods and/or currency that the user can use (e.g., by manipulation of a user character and/or other user-controlled element) within the virtual space.

The users may participate in the instance of the virtual space by controlling one or more of the available user controlled elements in the virtual space. Control may be exercised through control inputs and/or commands input by the users through client computing platforms 104. The users may interact with each other through communications exchanged within the virtual space. Such communications may include one or more of textual chat, instant messages, private messages, voice communications, and/or other communications. Communications may be received and entered by the users via their respective client computing platforms 104. Communications may be routed to and from the appropriate users through server(s) 102 (e.g., through the space module).

Game module 106 may be configured to facilitate interaction of the users with the game space by executing actions in the game space in response to receiving action requests from the users for the actions (e.g., via the space module). The actions may be associated with wait times that prevent execution of corresponding actions for an amount of time after the reception of the action requests. The actions may include a first action executed in the game space in response to receiving a first action request from a first user. The first action may be associated with a first wait time.

By way of example, an instance of a virtual space may comprise one or more user selectable in-space actions. An in-space action may be associated with a wait time. A wait time associated with the in-space action may prevent an execution of a number of corresponding actions for an amount of time after receiving a request for the in-space action. In a virtual space expressed in an instance of a game (e.g., an online game, a locally-operated game, or other game), a wait time may be associated with a time required to complete an in-game action. In such cases, the in-game action may comprise, for example, training (e.g., developing a skill), building, crafting, modifying, upgrading, trading, selling, or repairing an item, an equipment, or a structure; training, building, modifying, healing, requesting, upgrading, selling, or repairing an in-space unit; harvesting, refining, trading, selling, developing, spending, or consuming an in-space resource; using, performing, developing, modifying, upgrading, or training a skill, ability, or attribute; completing in-space travel (e.g., a virtual troop march), reloading a weapon, receiving assistance such as a hint or a clue, performing research to achieve levels of virtual knowledge, or other actions.

For example, in a game involving building virtual structures or items, a wait time may be associated with the time it takes for a virtual structure or item to be built, upgraded, or repaired. In yet another example involving a game with an aspect related to training virtual units (e.g., troops), a wait time may be associated with the time it takes to train the virtual units. In yet another example involving a game with an aspect related to acquisition of one or more levels of virtual knowledge (e.g., virtual research to obtain one or more technology levels), the wait time may be associated with the time it takes to acquire the virtual knowledge. In yet another example involving a game with an aspect related to traversal of a virtual distance by virtual units (e.g., a virtual troop march), a wait time may be associated with the time it takes for the virtual units to traverse the virtual distance. In another example involving a game with an aspect related to the development of a character, a wait time may be associated with the time it takes to use a skill or ability (e.g., a melee attack, a spell, etc.), or to interact with another player or a non-player character. Other examples of wait times may be used as well.

As used herein, a wait time may refer to, and be measured based on, a real-world time (e.g., measured in real-world increments of time) or a virtual-world time, which may or may not correspond to the real-world increments of time. Furthermore, a wait time refer to a number of turns in a turn-based game, which may in some implementations correspond to a virtual increment of time.

In some implementations, a wait time may be associated with a time required to recover from completing an in-space action. For example, in a game involving building virtual structures, a wait time may be associated with the time it takes to recover the amount of resources spent when building, upgrading, or repairing a virtual structure. In another example involving a game with an aspect related to the development of a character, a wait time may be associated with the time it takes to recover energy used when activating a skill or ability (e.g., a melee attack, a spell, etc.), or to interact with another player or an non-player character. In yet another example involving a game with an aspect related to the development of an army, a wait time may be associated with the time it takes recover from requesting special limited use units, abilities, or powers.

In some implementations, game module 106 may be configured to display an amount of wait time remaining for presentation a user of the game space. For example, the wait time may be presented as a countdown timer, a progress bar, a mask overlaying an action request to indicate that the action request may not be selected, or other wait time indicator.

In some implementations, wait times may apply to subsequent requests of the same action. In other implementations, wait times may apply to subsequent requests of the same action type. Action types may include building structures, items, equipment, or units; upgrading structures, items, equipment, or units; repairing structures, items, equipment, and/or units; upgrading skills or abilities; utilizing skills or abilities; harvesting resources; researching technology; trading items, equipment, or resources; traveling; or other action types.

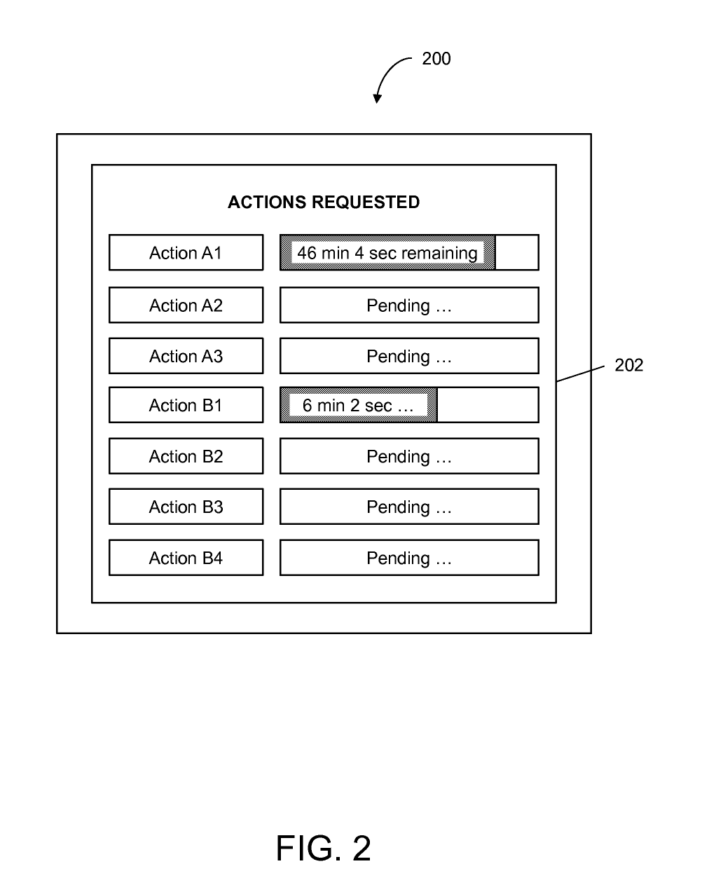

For example, FIG. 2 illustrates a user interface 200 depicting an information window 202 that indicates requested actions and times remaining for the requested actions to be completed, in accordance with one or more implementations. As shown by information window 202, actions A1, A2, A3, B1, B2, B3, and B4 may be requested actions. Actions A1, A2, and A3 may be actions of a first action type. Actions B1, B2, B3, and B4 may be actions of a second action type. As indicated by information window 202, execution of actions A2 and A3 may be prevented while there is still time remaining for action A1 to be completed, and execution of actions B2, B3, and B4 may be prevented while there is still time remaining for action B1 to be completed. In one use case, for instance, actions A1, A2, and A3 may be in the same action queue as one another as a result of being of the same action type as one another. Actions B1, B2, B3, and B4 may be in the same action queue as one another as a result of being of the same action type as one another. A predetermined number of actions in an action queue may, for example, be allowed to execute while other actions in the same action queue may not begin executing until one or more of the predetermined number of actions are completed (e.g., when there is no time remaining for the wait time associated with an action, when the wait time is instantly completed via activation of an item instance of a wait time reduction item for the action, etc.).

Store module 108 may be configured to present a store interface to the users. The store interface may present offers to the users to purchase item instances of wait time reduction items. The wait time reduction items may include a first wait time reduction item. An item instance of the first wait time reduction item may reduce a wait time associated with an executed action in the game space by a reduction time upon activation. As used herein, the term “offer” may refer to an offer or a request for an offer.

Wait time module 110 may be configured to reduce the first wait time for the first action by a first reduction time. The first wait time for the first action may be reduced by the first reduction time responsive to activation of a first item instance by the first user for the first action. In some implementations, the store module and/or the wait time module may be configured such that the first reduction time may not be apparent to the first user prior to the activation of the first item instance.

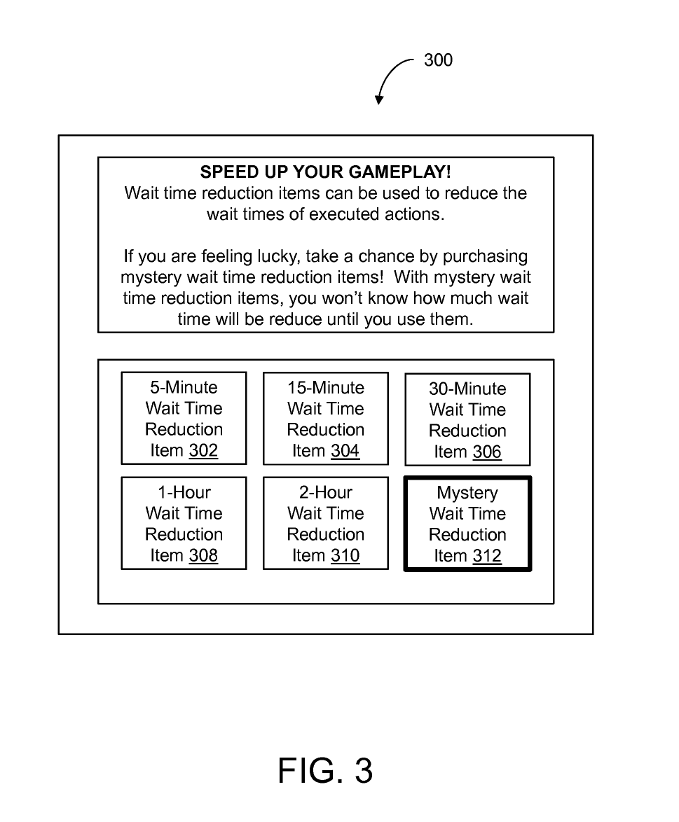

For example, FIG. 3 illustrates a store interface 300 that presents wait time reduction items for sale, in accordance with one or more implementations. As shown, store interface 300 may present offers to purchase item instances of wait time reduction items 302, 304, 306, 308, 310, 312, or other wait time reduction items. A reduction time by which a wait time associated with an executed action may be reduced upon activation of an item instance of one of wait time reduction items 302, 304, 306, 308, or 310 may be apparent to users before the item instance is purchased by and/or before the item instance is activated to reduce the wait time for the executed action. As an example, it may be apparent to users that activation of an item instance of wait time reduction item 302 will reduce a wait time of an executed action by 5 minutes, that activation of an item instance of wait time reduction item 304 will reduce a wait time of an executed action by 15 minutes, that activation of an item instance of wait time reduction item 306 will reduce a wait time of an executed action by 30 minutes, and so on.

On the other hand, still referring to FIG. 3, a reduction time by which a wait time associated with an executed action may be reduced upon activation of an item instance of wait time reduction item 312 may not be apparent to users before the item instance is activated to reduce the wait time for the executed action. In one use case, for example, a predetermined number of item instances of wait time reduction item 312 may be offered for sale. A first set of the item instances of wait time reduction item 312 may be configured to reduce a wait time of an executed action by 5 minutes upon activation of a purchased item instance of the first set by a user for the executed action. A second set of the item instances of wait time reduction item 312 may be configured to reduce a wait time of an executed action by 30 minutes upon activation of a purchased item instance of the second set by a user for the executed action. A third set of the item instances of wait time reduction item 312 may be configured to instantly complete an executed action upon activation of a purchased item instance of the third set by a user for the executed action. However, a user purchasing an item instance of wait time reduction item 312 may not know the particular set of item instances of wait time reduction item 312 from which of the item instance may be obtained until the user activates the item instance for an executed action.

In another use case, with respect to FIG. 3, an item instance of wait time reduction item 312 may be generated for a user in response to a purchase of the instance by the user. For example, the item instance of the wait time reduction item 312 may be generated such that a reduction time may be randomly selected and associated with the purchased item instance when the item instance is purchased by the user. However, in some use cases, while the purchased item instances may be associated with a particular reduction time by which a wait time of an executed action is to be reduced upon activation of the purchased item instance for the executed action, the particular reduction time may not be revealed to the user until the user activates the purchased item instance.

Item manager module 112 may be configured to manage the wait time reduction items. In some implementations, item manager module 112 may be configured to associate the first wait time reduction item with probabilities that an item instance of the first wait time reduction item will reduce a wait time associated with an executed action in the game space by individual reduction times upon activation by the users. The probabilities may include a first probability that an item instance of the first wait time reduction item will reduce a wait time associated with an executed action in the game space by the first reduction time upon activation.

In certain implementations, wait time module 110 may be configured to initiate a stochastic selection of one of a plurality of reduction times in accordance with the probabilities. The stochastic selection may be initiated by wait time module 110 responsive to the activation of the first item instance. The first reduction time may be selected based on the stochastic selection as a reduction time for reducing the first wait time for the first action.

By way of example, with respect to FIG. 3, a particular reduction time may not have been determined for an item instance of wait time reduction item 312 when the item instance is purchased. Instead, the reduction time for the item instance may be stochastically selected from among a plurality of reduction times upon activation of the item instance by a user for an executed action. The stochastically selection of the reduction time by which to reduce a wait time associated with the executed action may be based on the probabilities associated with wait time reduction item 312.

In one use case, for example, the associated probabilities may comprise a 70% chance that a wait time of an executed action will be reduced by 5 minutes upon activation of an item instance of wait time reduction item 312 for the executed action, a 25% chance that the wait time of the executed action will be reduced by 30 minutes upon activation of the item instance for the executed action, and a 5% chance that the executed action will be instantly completed upon activation of the item instance for the executed action.

In various implementations, the association of the first wait time reduction item with the probabilities by item manager module 112 may comprise an association of the first wait time reduction item with the probabilities after a purchasing of the first item instance by the first user. In some implementations, at a time of the purchase of the first item instance, the first wait time reduction item may be associated with other probabilities that an item instance of the first wait time reduction item will reduce a wait time associated with an executed action in the game space by individual reduction times upon activation by the users. In one implementation, the association of the first reduction item with the probabilities by item manager module 112 may modify the first reduction item to be associated with the probabilities such that the reduction of the first wait time for the first action is based on the modification of the first reduction item.

By way of example, in one scenario, at the time of the purchase of the first item instance, the first wait time reduction item may be associated with a 50% chance that a wait time of an executed action will be reduced by 5 minutes upon activation of an item instance of the first wait time reduction item for the executed action, a 30% chance that the wait time of the executed action will be reduced by 15 minutes upon activation of the item instance for the executed action, and a 20% chance that the wait time of the executed action will be reduced by 30 minutes upon activation of the item instance for the executed action.

In another scenario, after the purchase of the first item instance, the first wait time reduction item may then be associated with a 70% chance that a wait time of an executed action will be reduced by 5 minutes upon activation of an item instance of the first wait time reduction item for the executed action, a 25% chance that the wait time of the executed action will be reduced by 30 minutes upon activation of the item instance for the executed action, and a 5% chance that the executed action will be instantly completed upon activation of the item instance for the executed action.

The later association of the first wait time reduction item with the 70%, 25%, and 5% chances may, for example, cause all unused item instances of the first wait time reduction to reflect the later association in lieu of prior probability associations. As such, even though the first item instance was purchased before the later association occurred, the chances that a wait time associated with an executed action is reduced by particular reduction times upon activation of the first item instance may reflect the later associated probabilities (e.g., 70% for 5-minute reduction, 25% for 30-minute reduction, and 5% for instant completion). As an example, the modification to item instances purchased prior to the later association may be performed to create the appearance that the item instances of the first wait time reduction item have always had the chance of obtaining instant completion for an executed action upon completion, thereby increasing the incentive for users to purchase the item instances and/or reducing potential dissatisfaction with the item instances (e.g., dissatisfaction that the item instances of the first wait time reduction item did not have the possibility of instant completion or other high reduction times).

In certain implementations, the association of the first wait time reduction item with the probabilities by item manager module 112 may comprise an association of the first wait time reduction item with the probabilities prior to a purchasing of the first item instance by the first user. In some implementations, item manager module 112 may be configured to, after the purchase of the first item instance, associate the first wait time reduction item with other probabilities that an item instance of the first wait time reduction item will reduce a wait time associated with an executed action in the game space by individual reduction times upon activation by the users.

In one use case, prior to or at the time of the purchase of the first item instance, the first wait time reduction item may be associated with a 70% chance that a wait time of an executed action will be reduced by 5 minutes upon activation of an item instance of the first wait time reduction item for the executed action, a 25% chance that the wait time of the executed action will be reduced by 30 minutes upon activation of the item instance for the executed action, and a 5% chance that the executed action will be instantly completed upon activation of the item instance for the executed action.

In another use case, after the purchase of the first item instance, the first wait time reduction item may then be associated with a 50% chance that a wait time of an executed action will be reduced by 5 minutes upon activation of an item instance of the first wait time reduction item for the executed action, a 30% chance that the wait time of the executed action will be reduced by 15 minutes upon activation of the item instance for the executed action, and a 20% chance that the wait time of the executed action will be reduced by 30 minutes upon activation of the item instance for the executed action. Nevertheless, the later association of the first wait time reduction item with the 50%, 30%, and 20% chances may not modify the first item instance as a result of the first item instance being purchased before the later association. As such, the first item instance may still be associated with the 70% chance for the 5-minute reduction, 25% chance for the 30-minute reduction, and 5% chances for the instant completion upon activation of the first item instance. In this way, for example, previous promotions of the first wait time reduction (e.g., a promotion indicating the opportunity for instant completion of execution actions or other promotions) may not be affected by later probability associations with the first wait item reduction.

In one implementation, a second item instance of the first wait time reduction item may be purchased by a second user after the association of the first-wait time reduction item with the other probabilities. The actions may include a second action executed in the game space in response to receiving a second action request from the second user. The second action may be associated with a second wait time. Wait time module may be configured to reduce the second wait time for the second action in accordance with the other probabilities responsive to activation of the second item instance by the second user for the second action. Thus, item instances of the first wait time reduction purchased after a later association may reflect the other probabilities of the later association.

Server(s) 102, client computing platforms 104, external resources 114, and/or other components may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platforms 104, external resources 114, and/or other components may be operatively linked via some other communication media.

A given client computing platform 104 may include one or more processors configured to execute computer program modules. The computer program modules may be configured to enable an expert or user associated with client computing platform 104 to interface with system 100 and/or external resources 114, and/or provide other functionality attributed herein to client computing platforms 104. By way of non-limiting example, client computing platform 104 may include one or more of a desktop computer, a laptop computer, a handheld computer, a netbook, a smartphone, a gaming console, and/or other computing platforms.

External resources 114 may include sources of information, hosts and/or providers of virtual spaces outside of system 100, external entities participating with system 100, and/or other resources. In some implementations, some or all of the functionality attributed herein to external resources 114 may be provided by resources included in system 100.

In some implementations, server(s) 102 may include an electronic storage 116, one or more processor(s) 118, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 116 may comprise non-transitory storage media that electronically stores information. The electronic storage media of electronic storage 116 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 116 may include one or more virtual storage resources (e.g., cloud storage, a virtual private network, and/or other virtual storage resources). Electronic storage 116 may store software algorithms, information determined by processor(s) 118, information received from server(s) 102, information received from client computing platforms 104, and/or other information that enables server(s) 102 to function as described herein.

Processor(s) 118 is configured to provide information processing capabilities in server(s) 102. As such, processor(s) 118 may include one or more of a digital processor, an analog processor, a digital circuit designed to process information, an analog circuit designed to process information, a state machine, and/or other mechanisms for electronically processing information. Although processor(s) 118 is shown in FIG. 1 as a single entity, this is for illustrative purposes only. In some implementations, processor(s) 118 may include a plurality of processing units. These processing units may be physically located within the same device, or processor(s) 118 may represent processing functionality of a plurality of devices operating in coordination. Processor(s) 118 may be configured to execute modules 106, 108, 110, 112, and/or other modules. Processor(s) 118 may be configured to execute modules 106, 108, 110, 112, and/or other modules by software; hardware; firmware; some combination of software, hardware, and/or firmware; and/or other mechanisms for configuring processing capabilities on processor(s) 118. As noted, in certain implementations, a given client computing platform 104 may include one or more computer program modules that is the same as or similar to the computer program modules of server(s) 102. Client computing platform 104 may include one or more processors that are the same or similar to processor(s) 118 of server(s) 102 to execute such computer program modules of client computing platform 104.

It should be appreciated that although modules 106, 108, 110, and 112 are illustrated in FIG. 1 as being co-located within a single processing unit, in implementations in which processor(s) 118 includes multiple processing units, one or more of modules 106, 108, 110, and/or 112 may be located remotely from the other modules. The description of the functionality provided by the different modules 106, 108, 110, and/or 112 described below is for illustrative purposes, and is not intended to be limiting, as any of modules 106, 108, 110, and/or 112 may provide more or less functionality than is described. For example, one or more of modules 106, 108, 110, and/or 112 may be eliminated, and some or all of its functionality may be provided by other ones of modules 106, 108, 110, and/or 112. As another example, processor(s) 118 may be configured to execute one or more additional modules that may perform some or all of the functionality attributed below to one of modules 106, 108, 110, and/or 112.

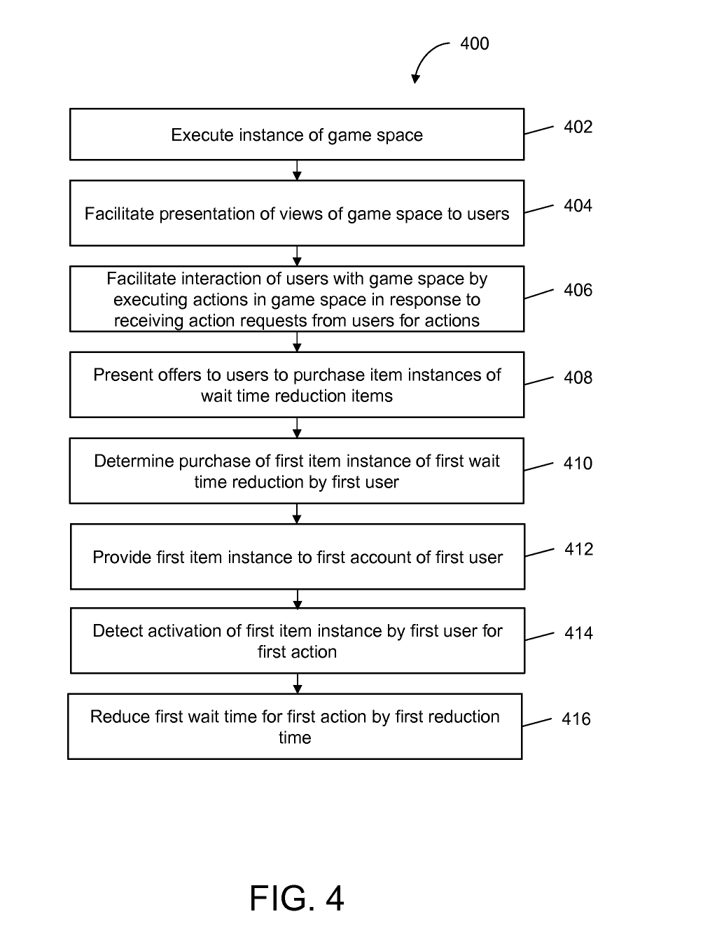

FIG. 4 illustrates a method of facilitating chance-based wait time reductions, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, a game instance of a game space may be executed. Operation 402 may be performed by a game module that is the same as or similar to game module 106, in accordance with one or more implementations.

At an operation 404, presentation of views of the game space to users may be facilitated. Operation 404 may be performed by a game module that is the same as or similar to game module 106, in accordance with one or more implementations.

At an operation 406, interaction of the users with the game space may be facilitated. For example, actions may be executed in the game space. The actions may be associated with wait times that prevent execution of corresponding actions for an amount of time after the reception of the action requests. The actions may include a first action executed in the game space in response to receiving a first action request from the first user. The first action may be associated with a first wait time. Operation 406 may be performed by a game module that is the same as or similar to game module 106, in accordance with one or more implementations.

At an operation 408, offers to purchase item instances of wait time reduction items may be presented to the users. The offers may be presented to the users via a store interface. In some implementations, the wait time reduction items may include a first wait time reduction item. An item instance of the first wait time reduction item may reduce a wait time associated with an executed action in the game space by a reduction time upon activation. A reduction time by which a wait time associated with an executed action may be reduced upon activation of an item instance of the first wait time reduction item may not be apparent to a user prior to activation of the item instance of the first wait time reduction item by the user. Operation 408 may be performed by a store module that is the same as or similar to store module 108, in accordance with one or more implementations.

At an operation 410, purchase of a first item instance of the first wait time reduction item by the first user may be determined. Operation 410 may be performed by a store module that is the same as or similar to store module 108, in accordance with one or more implementations.

At an operation 412, the first item instance may be provided to a first account of the first user. For example, the first item instance may be stored in an item inventory associated with the first user. Operation 412 may be performed by a store module that is the same as or similar to store module 108, in accordance with one or more implementations.

At an operation 414, activation of the first item instance by the first user for the first action may be detected. Operation 414 may be performed by a wait time module that is the same as or similar to wait time module 110, in accordance with one or more implementations.

At an operation 416, the first wait time for the first action may be reduced by a first reduction time. The first wait time may be reduced by the first reduction time responsive to the activation of the first item instance. The first reduction time may not be apparent to the first user prior to the activation of the first item instance. Operation 416 may be performed by a wait time module that is the same as or similar to wait time module 110, in accordance with one or more implementations.

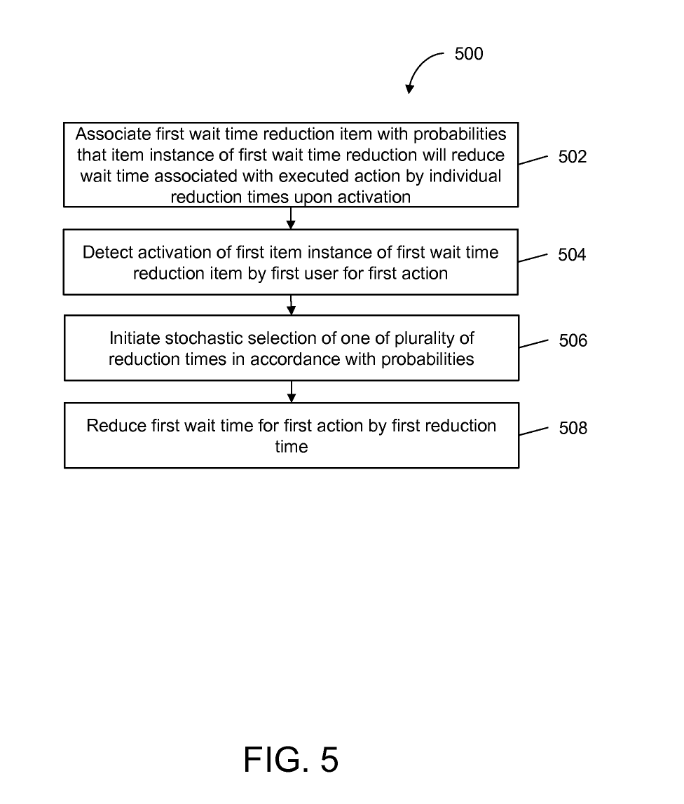

FIG. 5 illustrates a method of facilitating probability-associated wait time reductions, in accordance with one or more implementations. The operations of method 500 presented below are intended to be illustrative. In some implementations, method 500 may be accomplished with one or more additional operations not described, and/or without one or more of the operations discussed. Additionally, the order in which the operations of method 500 are illustrated in FIG. 5 and described below is not intended to be limiting.

In some implementations, method 500 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 500 in response to instructions stored electronically on an electronic storage medium. The one or more processing devices may include one or more devices configured through hardware, firmware, and/or software to be specifically designed for execution of one or more of the operations of method 500.

As discussed, in certain implementations, actions may be executed in a game space. The actions may be associated with wait times that prevent execution of corresponding actions for an amount of time after the reception of the action requests. The actions may include a first action executed in the game space in response to receiving a first action request from a first user. The first action may be associated with a first wait time.

In some implementations, offers to purchase item instances of a first wait time reduction item may be presented to users. An item instance of the first wait time reduction item may reduce a wait time associated with an executed action in the game space by a reduction time upon activation. A reduction time by which a wait time associated with an executed action may be reduced upon activation of an item instance of the first wait time reduction item may not be apparent to a user prior to activation of the item instance of the first wait time reduction item by the user.

At an operation 502, the first wait time reduction item may be associated with probabilities that an item instance of the first wait time reduction item will reduce a wait time associated with an executed action in the game space by individual reduction times upon activation by the users. The probabilities may include a first probability that an item instance of the first wait time reduction item will reduce a wait time associated with an executed action in the game space by the first reduction time upon activation. Operation 502 may be performed by an item manager module that is the same as or similar to item manager module 112, in accordance with one or more implementations.

At an operation 504, activation of a first item instance of the first wait time reduction item by a first user for a first action may be detected. Operation 504 may be performed by a wait time module that is the same as or similar to wait time module 110, in accordance with one or more implementations.

At an operation 506, stochastic selection of one of a plurality of reduction times may be initiated in accordance with the probabilities. The stochastic selection may be initiated responsive to the activation of the first item instance. Operation 506 may be performed by a wait time module that is the same as or similar to wait time module 110, in accordance with one or more implementations.

At an operation 508, the first wait time for the first action may be reduced by the first reduction time. The first wait time may be reduced by the first reduction time responsive to the first reduction time being stochastically selected as a reduction time for reducing the first wait time for the first action. Operation 508 may be performed by a wait time module that is the same as or similar to wait time module 110, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system for facilitating chance-based wait time reductions, the system comprising:
one or more processors configured by machine-readable instructions to:
execute an instance of a game space, and to facilitate presentation of views of the game space to users, and to facilitate interaction of the users with the game space by executing actions in the game space in response to receiving action requests over a network from client computing platforms associated with the users for the actions, wherein the actions are associated with wait times that prevent execution of corresponding actions for an amount of time after the reception of the action requests, wherein the actions include a first action executed in the game space in response to receiving a first action request from a first client computing platform associated with a first user, and wherein the first action is associated with a first wait time;
present a store interface to the users by causing displays associated with the client computing platforms to display the store interface, wherein the store interface presents offers to the users to purchase item instances of wait time reduction items, wherein the wait time reduction items include a first wait time reduction item, and wherein an item instance of the first wait time reduction item will reduce a wait time associated with an executed action in the game space by a reduction time upon activation; and
reduce the first wait time for the first action by a first reduction time responsive to activation of a first item instance by the first user for the first action, wherein first reduction time is not apparent to the first user prior to the activation of the first item instance.

2. The system of claim 1, wherein the one or more processors are configured by machine-readable instructions to associate the first wait time reduction item with probabilities that an item instance of the first wait time reduction item will reduce a wait time associated with an executed action in the game space by individual reduction times upon activation by the users, and wherein the probabilities include a first probability that an item instance of the first wait time reduction item will reduce a wait time associated with an executed action in the game space by the first reduction time upon activation.

3. The system of claim 2, wherein the one or more processors are configured by machine-readable instructions to initiate a stochastic selection of one of a plurality of reduction times in accordance with the probabilities responsive to the activation of the first item instance, and wherein the first reduction time is selected based on the stochastic selection as a reduction time for reducing the first wait time for the first action.

4. The system of claim 2, wherein the association of the first wait time reduction item with the probabilities comprises an association of the first wait time reduction item with the probabilities prior to a purchasing of the first item instance by the first user.

5. The system of claim 2, wherein the association of the first wait time reduction item with the probabilities comprises an association of the first wait time reduction item with the probabilities after a purchasing of the first item instance by the first user.

6. The system of claim 5, wherein, at a time of the purchase of the first item instance, the first wait time reduction item is associated with other probabilities that an item instance of the first wait time reduction item will reduce a wait time associated with an executed action in the game space by individual reduction times upon activation by the users, and wherein the association of the first reduction item with the probabilities modifies the first reduction item to be associated with the probabilities such that the reduction of the first wait time for the first action is based on the modification of the first reduction item.

7. The system of claim 2, wherein the association of the first wait time reduction item with the probabilities comprises an association of the first wait time reduction item with the probabilities prior to a purchasing of the first item instance by the first user, wherein the one or more processors are is configured by machine-readable instructions to, after the purchase of the first item instance, associate the first wait time reduction item with other probabilities that an item instance of the first wait time reduction item will reduce a wait time associated with an executed action in the game space by individual reduction times upon activation by the users.

8. The system of claim 7, wherein a second item instance of the first wait time reduction item is purchased by a second user after the association of the first-wait time reduction item with the other probabilities, wherein the actions include a second action executed in the game space in response to receiving a second action request from the second user, wherein the second action is associated with a second wait time, and wherein the second wait time is reduced for the second action in accordance with the other probabilities responsive to activation of the second item instance by the second user for the second action.

9. The system of claim 1, wherein the one or more processors are configured by machine-readable instructions such that the corresponding actions of an action include actions having a common action type with the action.

10. The system of claim 9, wherein the common action type includes a virtual construction or upgrade of one or more virtual structures, and wherein at least some of the wait times relate to the construction or upgrade of the one or more virtual structures.

11. The system of claim 9, wherein the common action type includes simulated research to achieve one or more levels of virtual knowledge, and wherein at least some of the wait times relate to achievement of the one or more levels of virtual knowledge.

12. The system of claim 9, wherein the common action type includes simulated training, and wherein at least some of the wait times relate to one or more simulated training goals.

13. The system of claim 9, wherein the common action type includes a traversal of a virtual distance by one or more virtual units, and wherein at least some of the wait times relate to the traversal of the virtual distance.

14. A computer-implemented method of facilitating chance-based wait time reductions, the method being implemented on a computer system that includes one or more physical processors, the method comprising:
executing an instance of a game space;
facilitating presentation of views of the game space to users;
facilitating interaction of the users with the game space by executing actions in the game space in response to receiving action requests over a network from client computing platforms associated with the users for the actions, wherein the actions are associated with wait times that prevent execution of corresponding actions for an amount of time after the reception of the action requests, wherein the actions include a first action executed in the game space in response to receiving a first action request from a first client computing platform associated with a first user, and wherein the first action is associated with a first wait time;
presenting a store interface to the users by causing displays associated with the client computing platforms to display the store interface, wherein the store interface presents offers to the users to purchase item instances of wait time reduction items, wherein the wait time reduction items include a first wait time reduction item, and wherein an item instance of the first wait time reduction item will reduce a wait time associated with an executed action in the game space by a reduction time upon activation; and
reducing the first wait time for the first action by a first reduction time responsive to activation of a first item instance by the first user for the first action, wherein the first reduction time is not apparent to the first user prior to the activation of the first item instance.

15. The method of claim 14, further comprising:
associating the first wait time reduction item with probabilities that an item instance of the first wait time reduction item will reduce a wait time associated with an executed action in the game space by individual reduction times upon activation by the users, wherein the probabilities include a first probability that an item instance of the first wait time reduction item will reduce a wait time associated with an executed action in the game space by the first reduction time upon activation.

16. The method of claim 15, further comprising:
initiating a stochastic selection of one of a plurality of reduction times in accordance with the probabilities responsive to the activation of the first item instance, wherein the first reduction time is selected based on the stochastic selection as a reduction time for reducing the first wait time for the first action.

17. The method of claim 15, wherein the association of the first wait time reduction item with the probabilities comprises an association of the first wait time reduction item with the probabilities after a purchasing of the first item instance by the first user.

18. The method of claim 17, wherein, at a time of the purchase of the first item instance, the first wait time reduction item is associated with other probabilities that an item instance of the first wait time reduction item will reduce a wait time associated with an executed action in the game space by individual reduction times upon activation by the users, and wherein the association of the first reduction item with the probabilities modifies the first reduction item to be associated with the probabilities such that the reduction of the first wait time for the first action is based on the modification of the first reduction item.

19. The method of claim 15, wherein the association of the first wait time reduction item with the probabilities comprises an association of the first wait time reduction item with the probabilities prior to a purchasing of the first item instance by the first user, the method further comprising:
associating, after the purchase of the first item instance, the first wait time reduction item with other probabilities that an item instance of the first wait time reduction item will reduce a wait time associated with an executed action in the game space by individual reduction times upon activation by the users.

20. The method of claim 19, wherein a second item instance of the first wait time reduction item is purchased by a second user after the association of the first-wait time reduction item with the other probabilities, wherein the actions include a second action executed in the game space in response to receiving a second action request from the second user, and wherein the second action is associated with a second wait time, the method further comprising:
reducing the second wait time for the second action in accordance with the other probabilities responsive to activation of the second item instance by the second user for the second action.
